(19) United States
(12) Patent Application Publication
(10) Pub. No.: US 2007/0155574 A1
(43) Pub. Date: Jul. 5, 2007

(54) Continuously variable transimission system for automatic

(76) Inventor: Yu-Fu Tseng, Hsinchu City (TW)

Correspondence Address: PRO-TECHTOR INTERNATIONAL SERVICES, 20775 NORADA CT., SARATOGA, CA, 95070, US

(21) Appl. No.: 11/326,032

(22) Filed: Jan. 4, 2006

(51) Int. Cl. F16H 37/02

(52) U.S. Cl. 475/207

(57) ABSTRACT

A continuously variable transmission system for an automatic includes a gear shifting transmission device, a continuously variable transmission device, and a reduction device. The continuously variable transmission device comprises a drive wheel, a driven wheel, and a transmission wheel. The drive wheel and the driven wheel together form an annular inner spherical face in linear frictional transmission contact with an outer spherical face of the transmission wheel. A speed-change control mechanism drives the transmission wheel to turn in response to an output speed of an output end of the driven wheel, thereby changing the linear contact area between the transmission wheel and the drive wheel and changing the linear contact area between the transmission wheel and the driven wheel such that the input speed on an input end of the driven wheel mating with the output speed.

### BACKGROUND OF THE INVENTION

1. Field of the Invention

The present invention relates to a continuously variable transmission system. More particularly, the present invention relates to a continuously variable transmission system for an automatic.

2. Description of the Related Art

The engine power of an automatic is transmitted by a transmission system to the wheels. A typical transmission system comprises a torque converter, a continuously variable transmission system, a transmission shaft, and a final transmission device, allowing the automatic to run on the road. The continuously variable transmission system allows the engine to provide various powers and torques, enabling the vehicle to run on all kinds of road surfaces. The maximum speed of an automobile depends on the maximum power output by the engine, which is the maximum speed of the engine. A speed ratio of 4:1 is sufficient for the vehicle to run on a smooth road at high speed. However, when starting a full-loaded vehicle or driving uphill, the continuously variable transmission system must be used to increase the speed of the engine and to reduce the speed of the wheel shaft to thereby increase the torque while pressing down the accelerator for increasing the output power of the engine.

Most continuously variable transmission systems include two, three, or four sets of planetary transmission mechanisms. Each set of planetary transmission mechanism includes a sun gear, a plurality of planetary gears meshed with the sun gear, and a ring gear meshed with the planetary gears. The shaft of each planetary gear is coupled to a common planet carrier. Each set of planetary transmission mechanism further includes a plurality of clutches and a belt-type braking device. The speed ratio can be automatically changed in response to the driving conditions. However, these planetary transmission mechanisms are complicated and expensive and provide a limited range in speed change.

### SUMMARY OF THE INVENTION

An objective of the present invention is to provide a continuously variable transmission system for an automatic that provides a wider range in speed change.

Another objective of the present invention is to provide a continuously variable transmission system for an automatic that provides a buffering effect and a boosting effect during shifting between forward gear and reverse gear.

A continuously variable transmission system for an automatic in accordance with the present invention comprises a gear shifting transmission device, a continuously variable transmission device, and a reduction device mounted in sequence for transmitting power from an engine of an automatic to a differentiator for driving the automatic.

The continuously variable transmission device comprises an arcuate, conic drive wheel, a driven wheel having a shape identical to that of the drive wheel and symmetrically arranged relative to the drive wheel, and a transmission wheel. An outer peripheral face of the drive wheel and an outer peripheral face of the driven wheel together form an annular inner spherical face defining a spherical space with a uniform radius.

The transmission wheel comprises a peripheral outer face that is an outer spherical face having a radius the same as that of the inner spherical face and mating with the inner spherical face of the drive wheel and the driven wheel. The transmission wheel includes a central support that is coincident with a center of the spherical space. The outer spherical face of the transmission wheel is in linear frictional transmission contact with the inner spherical face of the drive wheel and the driven wheel.

A speed-change control mechanism drives the transmission wheel to turn about the central support in response to an output speed of an output end of the driven wheel, thereby changing the linear contact area between the transmission wheel and the drive wheel and changing the linear contact area between the transmission wheel and the driven wheel such that the input speed on an input end of the driven wheel mating with the output speed.

Preferably, the drive wheel comprises a central power input shaft coupled with the gear shifting transmission device. The driven wheel comprises a central power output shaft coupled to the reduction device. A compression spring is mounted on the power output shaft for biasing the driven wheel to be in contact with the transmission wheel.

Preferably, the transmission wheel comprises a central shaft and a bearing sleeve mounted around the central shaft. Two diametrically opposed support rods extend radially outward from a circumference of the bearing sleeve to form a central support for the transmission wheel. A worm sector is mounted on an end of the bearing sleeve that is distal to the transmission wheel. The speed-change control mechanism further comprises a control shaft that is movable along an axial direction under control. A circular rack is mounted around the control shaft and meshed with the worm sector.

Preferably, the speed-change control mechanism further comprises a centrifugal housing rotatably mounted on the control shaft. A gear and a reduction gear set are mounted on a circumference of the centrifugal housing to allow the centrifugal housing to be driven by the power output shaft of the driven wheel. Two diametrically opposed, symmetrically arranged antigravity blocks are rotatably mounted in the centrifugal housing. An arm extends inward from each antigravity block. A guide is rotatably mounted in the centrifugal housing and includes two opposed radial guiding slots. Each arm includes an end slidingly received in an associated guiding slot, allowing axial movement of the control shaft and the circular rack on the control shaft.

Preferably, a tension spring is mounted between the antigravity blocks.

The continuously variable transmission system may further comprise another two transmission wheels, with the three transmission wheels mounted in the annular inner spherical space at regular angular intervals. Each of two ends of each support rod of one of the transmission wheels includes a gear that meshes with another gear on an associated support rod of an associated one of the remaining transmission wheels, allowing synchronous rotational movement of the three transmission wheels.

Preferably, the transmission wheel comprises an elastomeric anti-sliding layer on the outer spherical face thereof.

Preferably, the gear shifting transmission device comprises:
an input shaft including a front end to which the engine power is transmitted, the input shaft of the gear shifting transmission device further comprising a rear end on which ratchet teeth for reverse gear and ratchet teeth for forward gear are provided, the input shaft of the gear shifting transmission device further comprising an axial hole for coupling with the power input shaft of the drive wheel;
a sun gear fixed on the power input shaft of the drive wheel;
front and rear planet carriers;
a plurality of planetary gears meshed with outer circumferential teeth of the sun gear, a shaft of each planetary gear including two ends respectively coupled to the front and rear planet carriers;
a first ratchet ring mounted on the front planet carrier for engaging with the ratchet teeth for forward gear on the input shaft;
a first brake disc mounted on a circumference of the rear planet carrier;
a plurality of first brake shoes mounted on both sides of the first brake disc;
a ring gear including inner circumferential teeth meshed with each planetary gear;
a sleeve extending forward from a circumference of the ring gear and including an end wall that is opposite to the ring gear, with the input shaft of the gear shifting transmission device extending through the end wall;
a second ratchet ring mounted on a side of the end wall for engaging with the ratchet teeth for reverse gear on the input shaft of the gear shifting transmission device;
a second brake disc mounted on a circumference of the end wall;
a plurality of second brake shoes mounted on both sides of the second brake disc; and
a shifter coupled to the input shaft of the gear shifting transmission device for moving the input shaft along an axial direction;
wherein when the input shaft of the gear shifting transmission device is moved by the shifter to engage the ratchet teeth for forward gear on the input shaft with the first ratchet ring on the front planet carrier, the second brake shoes brake the second brake disc on the end wall of the sleeve, the drive gear and the power input shaft of the drive gear are driven in an accelerating transmission mode via the front planet carrier, the planetary gears, and the sun gear; and
wherein when the input shaft of the gear shifting transmission device is moved by the shifter to engage the ratchet teeth for reverse gear on the input shaft with the second ratchet ring on the end wall, the first brake shoes brake the first brake disc on the rear planet carrier, the drive gear and the power input shaft are driven in a reverse direction in the accelerating transmission mode via the ring gear, the planetary gears, and the sun gear.

Other objectives, advantages, and novel features of the invention will become more apparent from the following detailed description when taken in conjunction with the accompanying drawings.

### BRIEF DESCRIPTION OF THE DRAWINGS

FIG. 1 is a sectional view of an embodiment of a continuously variable transmission system for an automatic in accordance with the present invention, with the continuously variable transmission being of front-wheel drive type.

FIG. 2 is a sectional view of a gear shifting transmission device of the continuously variable transmission system in FIG. 1.

FIG. 3 is a sectional view illustrating a planetary gear mechanism in FIG. 2.

FIG. 4 is a sectional view similar to FIG. 2, with the continuously variable transmission system is in a reverse gear.

FIG. 5 is an enlarged view of a portion of FIG. 1, with the continuously variable transmission system in an accelerating transmission mode.

FIG. 6 is a view similar to FIG. 5, with the continuously variable transmission system in a constant speed mode.

FIG. 7 is a sectional view taken along plane 7-7 in FIG. 6.

FIG. 8 is a schematic view illustrating a speed-change control mechanism of the continuously variable transmission system.

FIG. 9 is a view similar to FIG. 5, with the continuously variable transmission system in a reduction transmission mode.

FIG. 10 is a view illustrating arrangement of three sets of transmission wheels in FIG. 7.

FIG. 11 is a sectional view illustrating another embodiment of the continuously variable transmission system for an automatic in accordance with the present invention, with the continuously variable transmission system being of rear-wheel drive type.

### DETAILED DESCRIPTION OF THE PREFERRED EMBODIMENTS

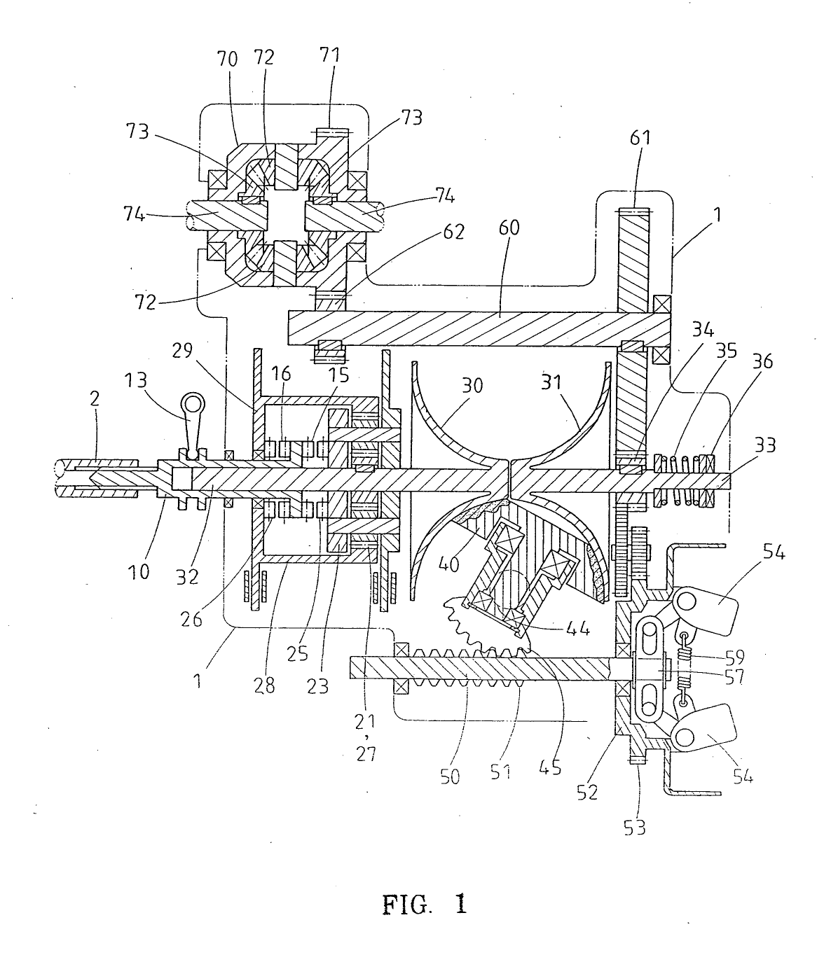

Referring to FIG. 1 illustrates an embodiment of a continuously variable transmission system for an automatic in accordance with the present invention. The illustrated continuously variable transmission system is of front-wheel drive type and comprises a casing 1 in which a gear shifting transmission device, a continuously variable transmission device, and a reduction device are mounted in sequence for transmitting engine power of the automatic in sequence and for automatically performing continuously variable transmission, thereby driving the wheels of the vehicle via a final transmission system.

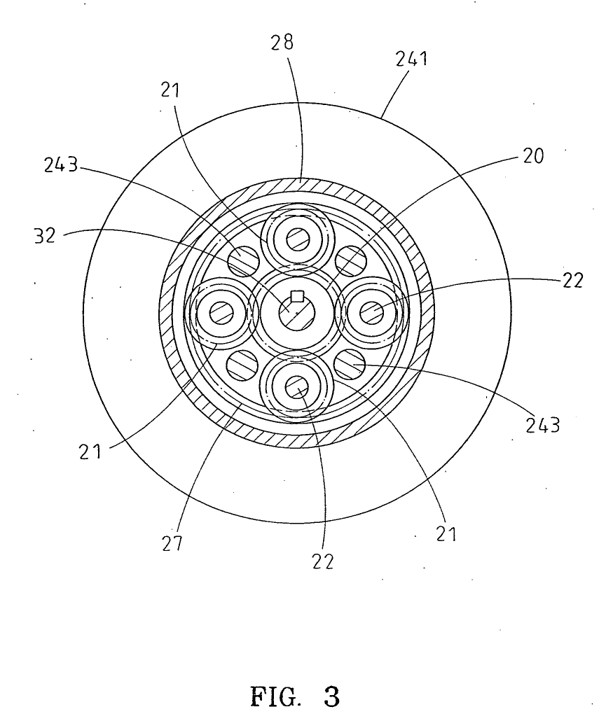

The gear shifting transmission device shown in FIGS. 1 through 4 comprises an input shaft 10 rotatably supported at a front end of the casing 1. The input shaft 10 comprises a plurality of sliding keys 11 for slidingly engaging with a power shaft 2 of the engine of the automatic. The input shaft 10 further includes an axial hole 12 having an opening that faces rearwards. The continuously variable transmission device comprises a drive wheel 30 having a central power input shaft 32 that is slidingly inserted into the axial hole 12.

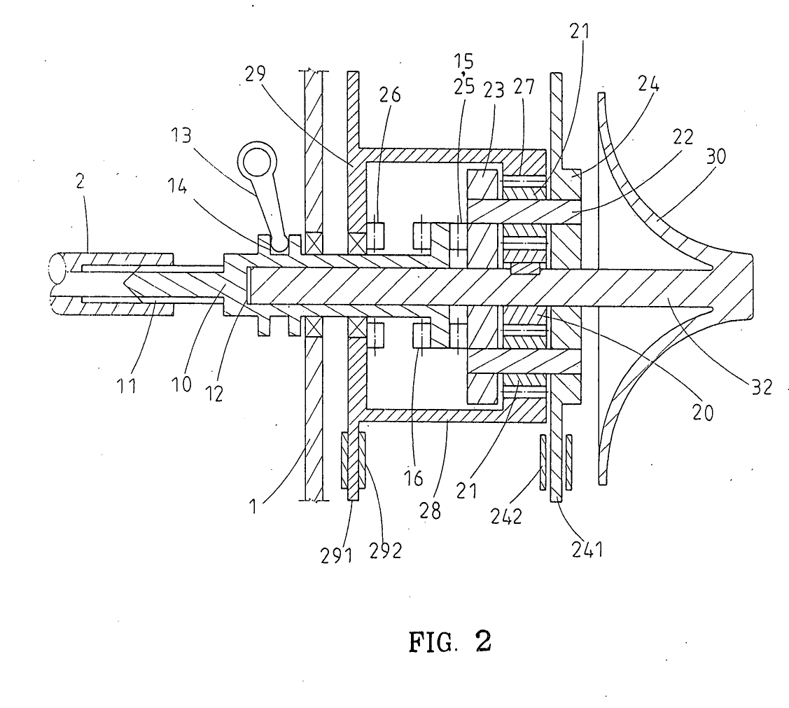

Mounted on a rear end of the input shaft 10 are ratchet teeth 15 for forward gear and ratchet teeth 16 for reverse gear. An engaging groove 14 provided in an exposed section of the input shaft 10 outside the casing 1, and a shifter 13 has an end engaged in the engaging groove 14 for moving the input shaft 10 for gear shifting purposes, best shown in FIG. 2.

The gear shifting transmission device comprises a planetary gear mechanism mounted on the input shaft 10 and the central power input shaft 32. The planetary gear mechanism comprises a sun gear 20 fixed on the central power input shaft 32, a plurality of planetary gears 21 meshed with the outer circumferential teeth of the sun gear 20, and front and rear planet carriers 23 and 24. A plurality of supporting rods 243 are connected between the front and rear planet carriers 23 and 24. Two ends of a shaft 22 of each planetary gear 21 are respectively coupled to the front and rear planet carriers 23. A ratchet ring 25 is mounted on the front planet carrier 23 for engaging with the ratchet teeth 15 for forward gear on the input shaft 10. A brake disc 242 is provided on a circumference of the rear planet carrier 24, and a plurality of brake shoes 242 are mounted on both sides of the brake disc 241. A ring gear 27 includes inner circumferential teeth meshed with the teeth of each planetary gear 21. A sleeve 28 extends forward from a circumference of the ring gear 27. The sleeve 28 includes an end wall 29 that is opposite to the ring gear 27 and that has a hole (not labeled) through which the input shaft 10 rotatably extends. A ratchet ring 26 is mounted on a side of the end wall 29 for engaging with the ratchet teeth 16 for reverse gear on the input shaft 10. A brake disc 291 is mounted on a circumference of the end wall 29, and a plurality of brake shoes 292 are mounted on both sides of the brake disc 291.

The gear shifting transmission device in FIG. 1 is in a neutral gear. In this state, the input shaft 10 and the engine power shaft 2 rotate synchronously whereas the gear shifting transmission device is not in operation.

Referring to FIG. 2, when the shifter 13 is operated to move the input shaft 10 rearwards (rightwards in FIG. 2), the ratchet teeth 15 for forward gear on the input shaft 10 are engaged with the ratchet ring 25 on the front planet carrier 23 whereas the brake shoes 292 gradually brake the brake disc 291 on the end wall 29 opposite to the ring gear 27 for buffering transmission of the engine power and for locking the ring gear 27. Thus, the front and rear planet carriers 23 and 24 are synchronously driven by the input shaft 10 via transmission by the ratchet teeth 15 and the ratchet ring 25. The planetary gears 21 rotate along the ring gear 27 and drive the sun gear 20 (see FIG. 1). As a result, the drive wheel 30 and the power input shaft 32 rotates in the same direction in an accelerating transmission mode, allowing forward driving of the automatic.

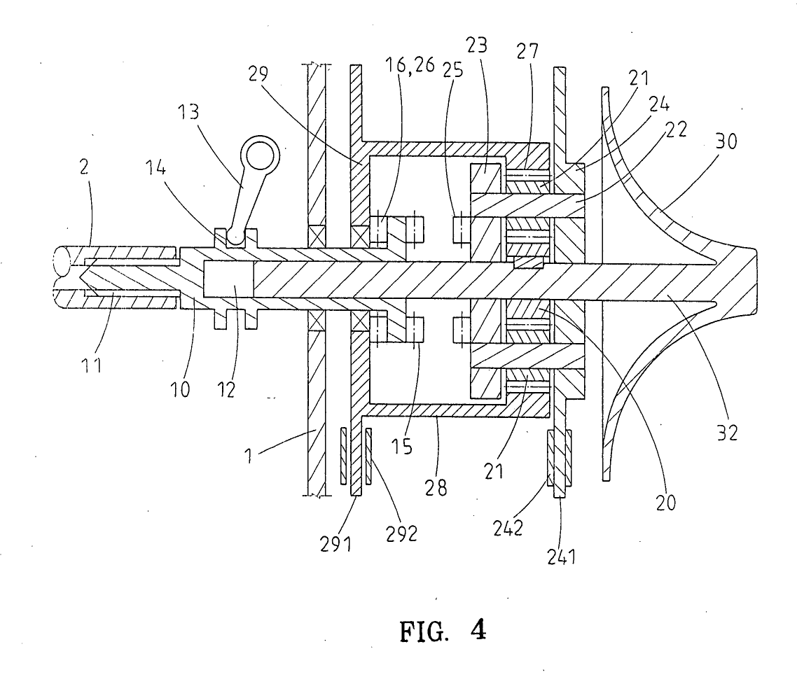

Referring to FIG. 4, when the shifter 13 is operated to move the input shaft 10 forwards (leftwards in FIG. 4), the ratchet teeth 16 for reverse gear on the input shaft 10 are engaged with the ratchet ring 26 on the end wall 29 opposite to the ring gear 27 whereas the brake shoes 242 gradually brake the brake disc 241 on the rear planet carrier 24, thereby fixing the front and rear planet carriers 23 and 24. Thus, the ring gear 27 is driven by the input shaft 10 via transmission by the ratchet teeth 16 for reverse gear and the ratchet ring 26. The planetary gears 21 rotate in situ and drive the sun gear 20. As a result, the drive wheel 30 and the power input shaft 32 rotates in an accelerating transmission mode, allowing rearward driving of the automatic.

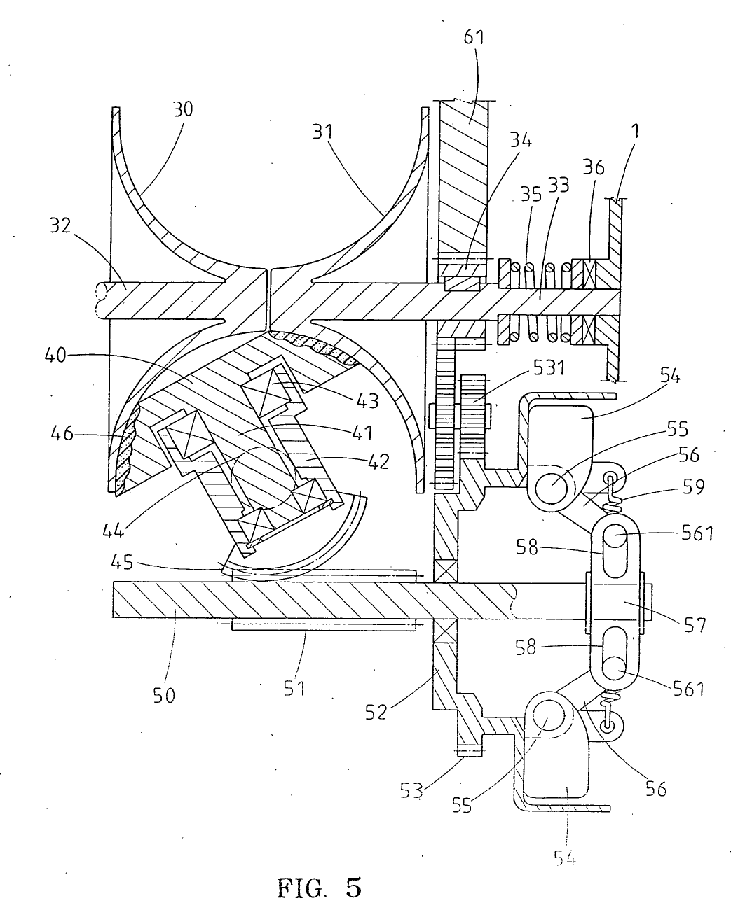

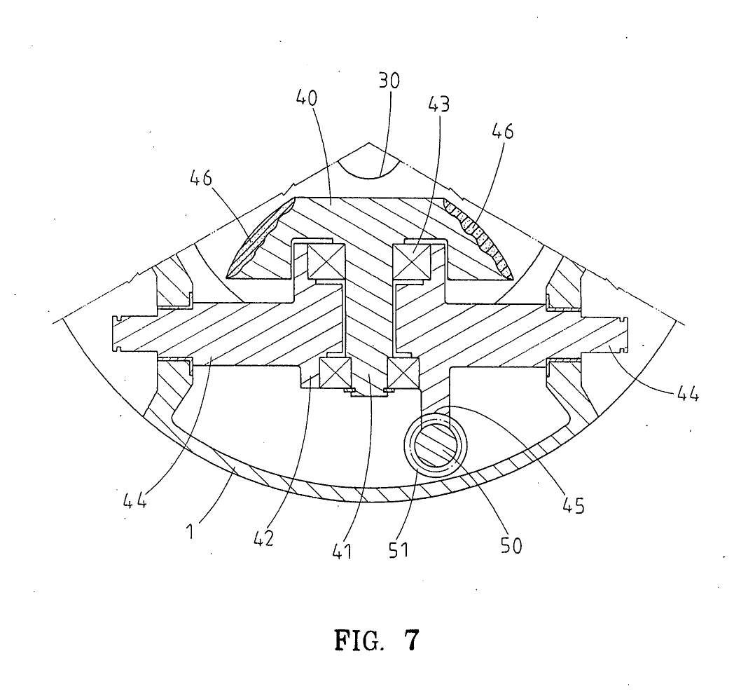

Referring to FIGS. 5 through 8, the continuously variable transmission device comprises arcuate, conic drive wheel 30, a driven wheel 31 having a shape identical to that of the drive gear 30 and symmetrically arranged relative to the drive wheel 30, at least one transmission gear 40, and a speed-change control mechanism. As mentioned above, the central power input shaft 32 of the drive wheel 30 is engaged with the input shaft 10 and the sun gear 20 (see FIG. 1). The driven wheel 31 includes a central power output shaft 33 is engaged with and thus drives the reduction device.

The drive wheel 30 and the driven wheel 31 may be made of metal or carbon fiber. An outer peripheral face of the drive wheel 30 and an outer peripheral face of the driven wheel 31 together form an annular inner spherical face defining a spherical space with a uniform radius. A central support of the transmission wheel 40 is coincident with the center of the spherical space. A peripheral outer face of the transmission wheel 40 mates with the inner spherical face defined by the drive wheel 30 and the driven wheel 31. Preferably, the radius of the transmission wheel 40 is the same as that of the inner spherical face of the driven wheel 30 and the driven wheel 31, with the peripheral outer face of the transmission wheel 40 being an outer spherical face that is in linear frictional contact with the inner spherical face of drive wheel 30 and the driven wheel 31 for transmission purposes.

The speed-change control mechanism outputs speed at an output end of the driven wheel 31 and the power output shaft 33 under load. This causes the transmission wheel 40 to turn about its central support to adjust the angular position of the transmission wheel 40, thereby changing the linear contact area between the transmission wheel 40 and the drive wheel 30 and the linear contact area between the transmission wheel 40 and the driven wheel 31. This allows the speed input to the input end of the driven wheel 31 to be automatically adjusted for mating with the output speed, thereby changing the speed and torque in response to the conditions of the automatic and the road surfaces.

In a preferred embodiment, the power output shaft 33 of the driven wheel 31 has an end section rotatably supported by the casing 1. A compression spring 35 and a thrust bearing 36 are mounted on the extended section of the power output shaft 33 to bias the inner spherical face (i.e., the outer peripheral face) of the driven wheel 31 to tightly press against the outer spherical face of the transmission wheel 40. The transmission wheel 40 is made of metal and includes a rubber-like elastomeric anti-slide layer 46 on an outer face to form the outer spherical face. This turns the linear contact friction transmission into planar contact friction transmission, thereby improving the frictional transmission. Alternatively, the elastomeric anti-slide layer can be formed on the outer peripheral face of the drive wheel 30 or the driven wheel 31.

Still referring to FIGS. 5 through 7, the transmission wheel 40 includes a central shaft 41, a bearing sleeve 42 mounted around the central shaft 41, and bearings 43. Two diametrically opposed support rods 44 extend radially outward from a circumference of the bearing sleeve 42 to form the central support for the transmission wheel 40. Each support rod 44 has an end rotatably supported by the casing 1. A worm sector 45 is mounted on an end of the bearing sleeve 42 that is distal to the transmission wheel 40. The speed-change control mechanism further comprises a control shaft 50 rotatably supported by the casing 1. A circular rack 51 is mounted around the control shaft 50 and meshes with the worm sector 45. When the control shaft 50 is moved axially, the worm sector 45 is moved and the support rods 44 pivot to thereby change the angular position of the transmission wheel 40.

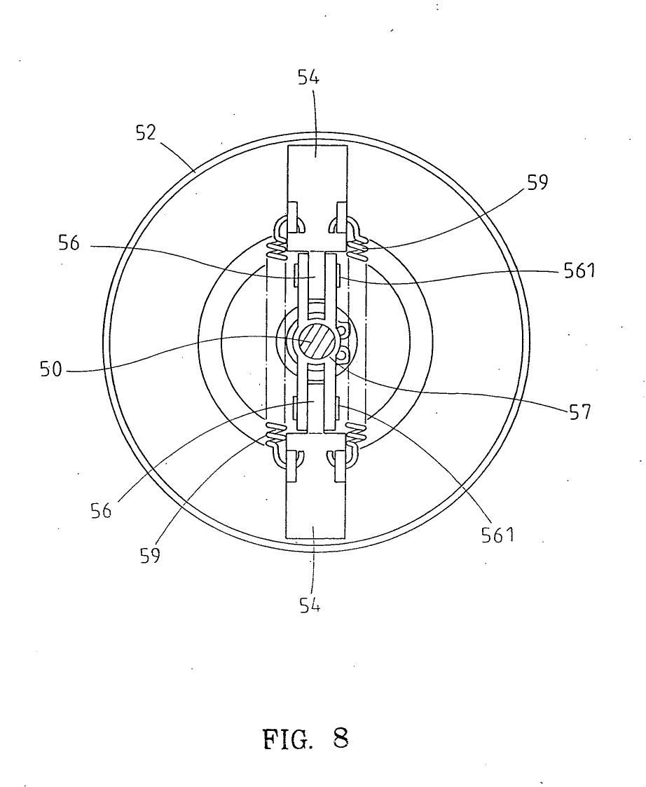

Referring to FIGS. 5 and 8, rotatably mounted on the control shaft 50 is a centrifugal housing 52 that may rotate in situ. A gear 53 and a reduction gear set 531 are mounted on a circumference of the centrifugal housing 52 for cooperating with a gear 34 on the power output shaft 33 of the driven wheel 31 for reduction purposes while allowing the centrifugal housing 52 to rotate in situ on the control shaft 50.

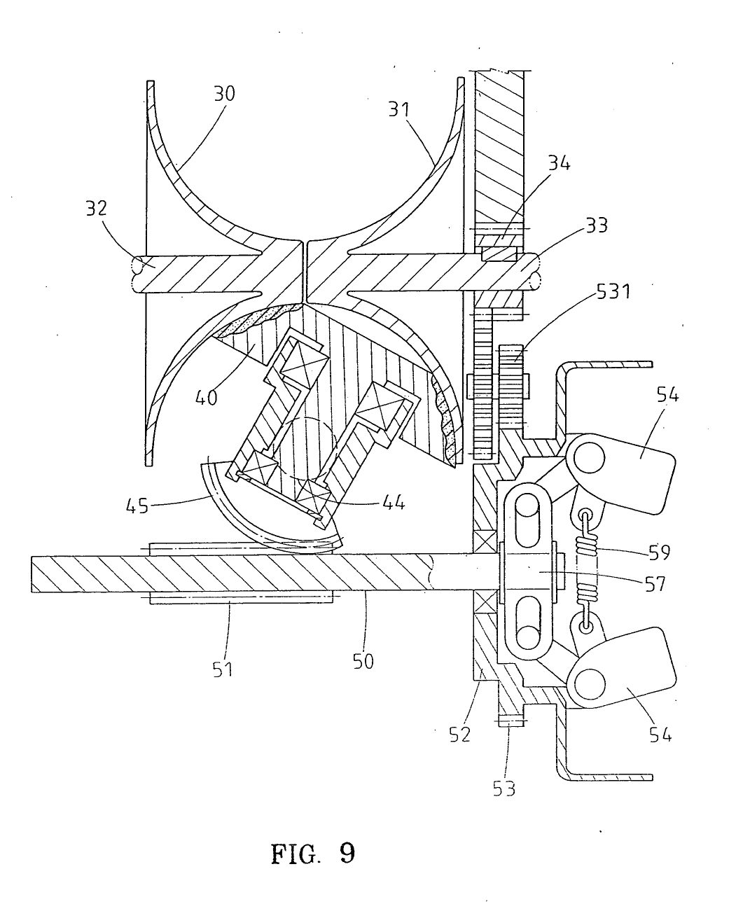

Two diametrically opposed, symmetrically arranged antigravity blocks 54 are rotatably mounted in the centrifugal housing 52 by two eccentric pins 54. An arm 56 extends inward from each antigravity block 54 at a position adjacent to the associated eccentric pin 54 toward an end section of the control shaft 50. A guide 57 is rotatably mounted in the centrifugal housing 52 and includes two opposed radial guiding slots 58. A peg 561 on a distal end of each arm 56 is slidingly received in an associated one of the guiding slots 58 of the guide 57 for moving the control shaft 50 along the axial direction while allowing the guide 57 to rotate freely on the control shaft 50. In a preferred embodiment, a tension spring 59 is mounted between the antigravity blocks 54 for normally biasing the antigravity blocks 54 inwards (see FIG. 9) for the purpose of moving the control shaft 50 forwards (leftwards in figures). It is noted that the number of the antigravity blocks 54 may be three or four, with these antigravity blocks 54 spaced at regular angular intervals.

The continuously variable transmission system in accordance with the present invention transmits the power of engine through the gear shifting transmission device and proceeds with buffering, gear selection, and accelerating operations to drive the drive wheel 30 and the power input shaft 32. Referring to FIG. 5, the driven gear 31 and the power output shaft 33 are turned in an accelerating transmission mode via transmission by the transmission wheel 40. Since the gear 34 on the power output shaft 33 meshes with a gear 61 of the transmission shaft 60 of the reduction device and since another gear 62 on the transmission shaft 60 meshes with peripheral teeth 71 of a differentiator 70 (see FIG. 1), the differentiator 70 and two bevel gears 72 of the differentiator 70 rotate and drive two front wheel shafts 74 and bevel gears 73 on the front wheel shafts 74. Hence, the front wheels of the automatic turn. Meanwhile, the gear 34 on the power output shaft 33 of the driven wheel 31 drives the centrifugal housing 52, which, in turn, moves the control shaft 50 and the rack 51 axially via the antigravity blocks 54 and the guide 57. This adjusts the angular positions of the worm sector 45 and the transmission wheel 40, thereby achieving continuously variable transmission.

In the maximum accelerating transmission mode shown in FIG. 5, the drive wheel 30, the driven wheel 31, and the transmission wheel 40 have the same radius and are in friction contact transmission through the spherical surface such that the driven wheel 31 and the power output shaft 33 of the driven wheel 31 rotate in accelerating transmission mode, with the contact points between the drive wheel 30 and the transmission wheel 40 having the same speed ratio and with the contact points between the driven wheel 31 and the transmission wheel 40 having the same speed ratio, avoiding power loss due to the difference in speed ratio. Further, the output speed from the output shaft 33 of the driven wheel 31 is transmitted via the gear 34, the reduction gear set 531, and the gear 53 to drive the centrifugal housing 52, the antigravity blocks 54, and the guide 57. The antigravity blocks 54 sway outward under high-speed rotation and thus move the control shaft 50 and the rack 51 rearwards (rightwards in the figures) through the arms 56 and the guiding slots 58 of the guide 57. The worm sector 45 and the transmission wheel 40 are turned. In other words, the angular position of the transmission wheel 40 is changed such that the input speed obtained from the transmission wheel 40 through the driven wheel 31 is equal to the output speed of the power output shaft 33, providing a wider range for continuously variable transmission.

In a case that the output speed of the power output shaft 33 of the driven wheel 31 is reduced in response to the conditions of the automatic and/or the road surface, the speed-change control mechanism is actuated. The antigravity blocks 54 move inward due to a reduction in the centrifugal force, resulting in gradual forward (leftward in the figures) movement of the control shaft 50 and the rack 51 via the guide 57. The angular positions of the transmission wheel 40 and the worm sector 45 are changed to reduce the speed ratio, switching the mode to constant speed mode or reduction transmission mode.

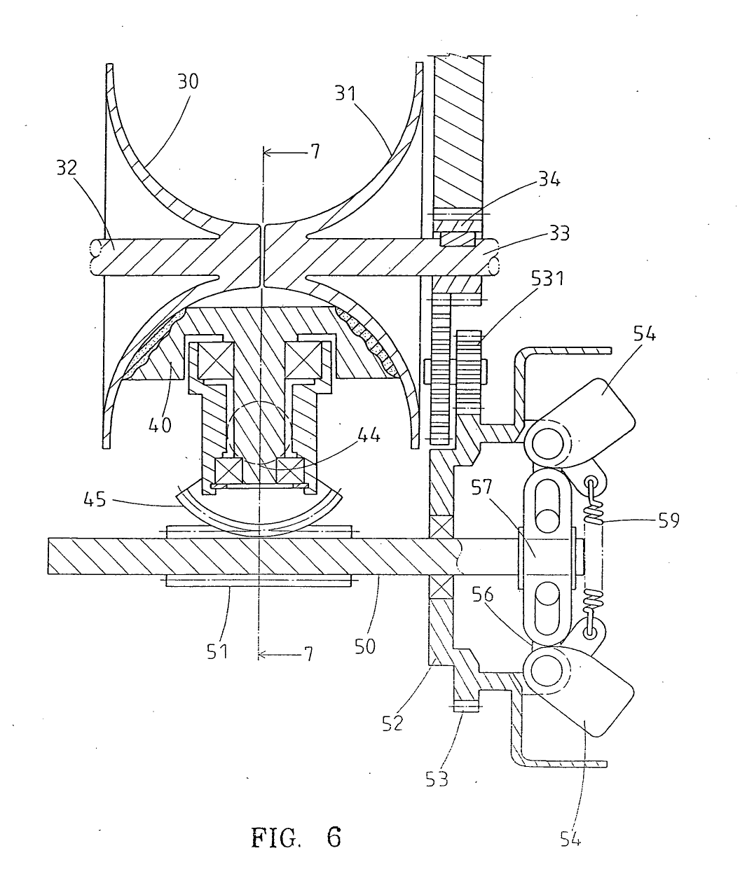

The continuously variable transmission system in FIG. 6 is in the constant speed mode. When the output speed of the power output shaft 33 of the driven wheel 31 is further reduced due to the conditions of the automatic and the road surface, the control shaft 50 and the rack 51 move further forwards (leftwards in the figures) along the axial direction via the speed-change control mechanism, switching the angular positions of the transmission wheel 40 and the worm sector 45 to the reduction transmission mode while gradually increasing the reduction ratio. The final, maximum reduction transmission state is shown in FIG. 9.

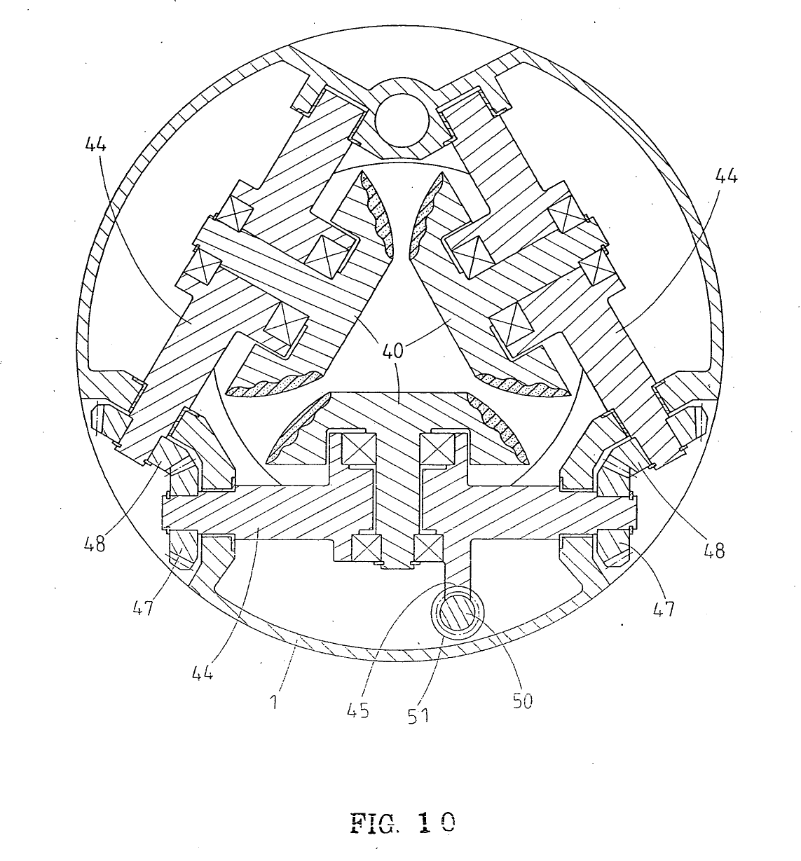

Instead of only one set of transmission wheel 40, the continuously variable transmission system may use three sets of transmission wheels 40 that are spaced at regular, angular intervals, as shown in FIG. 10. One of the transmission wheels 40 includes a worm sector 45 for meshing with and controlling a rack 51 on the control shaft 50 of the speed-change control mechanism. This transmission wheel 40 further includes two radial support rods 44 each having a gear 47 mounted thereon for meshing with a gear 48 on an associated one of the radial support rods 44 of an associated one of the other two transmission wheels 40. Thus, the angular positions of the three transmission wheels 40 can be adjusted synchronously, thereby increasing the power transmitted through friction.

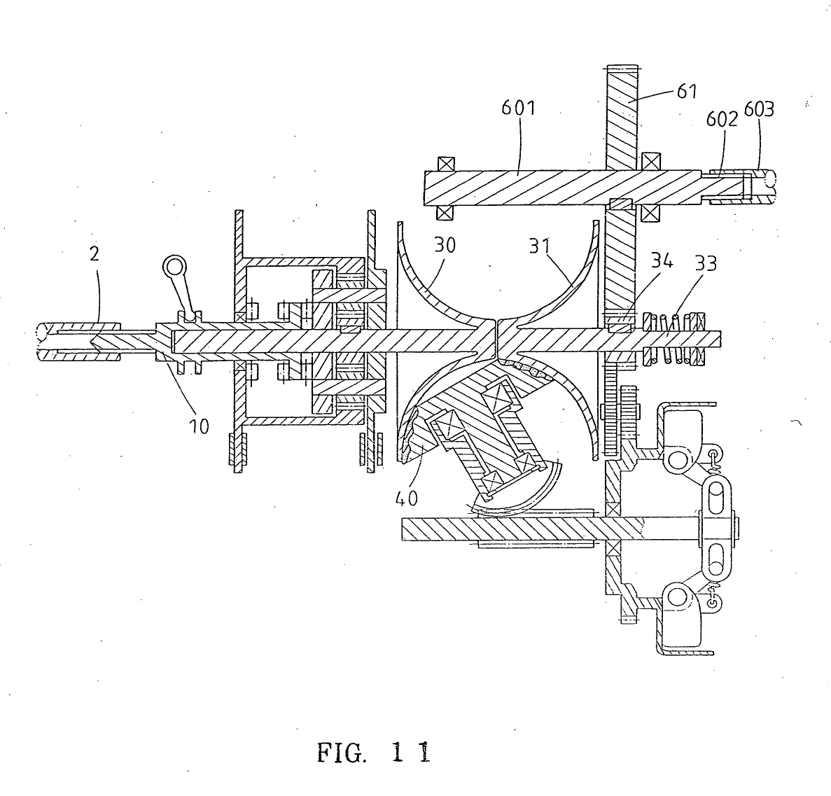

The continuously variable transmission system shown in FIG. 11 is for a rear-wheel drive type automatic. The continuously variable transmission device of the continuously variable transmission system also includes a drive wheel 30, a driven wheel 31, and a transmission wheel 40. The power output shaft 33 of the driven wheel 33 drives a transmission shaft 601 of the reduction device via gears 34 and 61 and then synchronously drives a final transmission shaft 603 and a rear wheel differentiator (not shown) via a sliding key 602.

Since the transmission wheel 40 is in spherical-face-friction-contact with the drive wheel 30 and the driven wheel 31, identical speed ratio can be obtained at the areas providing frictional transmission, avoiding power loss due to speed ratio difference and providing a wider range for continuously variable transmission.

Although specific embodiments have been illustrated and described, numerous modifications and variations are still possible without departing from the essence of the invention. The scope of the invention is limited by the accompanying claims.

What is claimed is:

1. A continuously variable transmission system for an automatic, comprising a gear shifting transmission device, a continuously variable transmission device, and a reduction device mounted in sequence for transmitting power from an engine of an automatic to a differentiator for driving the automatic;
the continuously variable transmission device comprising an arcuate, conic drive wheel, a driven wheel having a shape identical to that of the drive wheel and symmetrically arranged relative to the drive wheel, and a transmission wheel, an outer peripheral face of the drive wheel and an outer peripheral face of the driven wheel together forming an annular inner spherical face defining a spherical space with a uniform radius, the transmission wheel comprising a peripheral outer face that is an outer spherical face having a radius the same as that of the inner spherical face and mating with the inner spherical face of the drive wheel and the driven wheel, the transmission wheel including a central support that is coincident with a center of the spherical space, the outer spherical face of the transmission wheel being in linear frictional transmission contact with the inner spherical face of the drive wheel and the driven wheel; and
a speed-change control mechanism driving the transmission wheel to turn about the central support in response to an output speed of an output end of the driven wheel, thereby changing the linear contact area between the transmission wheel and the drive wheel and changing the linear contact area between the transmission wheel and the driven wheel such that the input speed on an input end of the driven wheel mating with the output speed.

2. The continuously variable transmission system for an automatic as claimed in claim 1 wherein the drive wheel comprises a central power input shaft coupled with the gear shifting transmission device, the driven wheel comprising a central power output shaft coupled to the reduction device, a compression spring being mounted on the power output shaft for biasing the driven wheel to be in contact with the transmission wheel.

3. The continuously variable transmission system for an automatic as claimed in claim 1 wherein the transmission wheel comprises a central shaft and a bearing sleeve mounted around the central shaft, two diametrically opposed support rods extending radially outward from a circumference of the bearing sleeve to form a central support for the transmission wheel, a worm sector being mounted on an end of the bearing sleeve that is distal to the transmission wheel, the speed-change control mechanism further comprising a control shaft that is movable along an axial direction under control, a circular rack being mounted around the control shaft and meshed with the worm sector.

4. The continuously variable transmission system for an automatic as claimed in claim 3 wherein the speed-change control mechanism further comprises a centrifugal housing rotatably mounted on the control shaft, a gear and a reduction gear set being mounted on a circumference of the centrifugal housing to allow the centrifugal housing to be driven by the power output shaft of the driven wheel, two diametrically opposed, symmetrically arranged antigravity blocks being rotatably mounted in the centrifugal housing, an arm extending inward from each said antigravity block, a guide being rotatably mounted in the centrifugal housing and including two opposed radial guiding slots, each said arm including an end slidingly received in an associated one of the guiding slots, allowing axial movement of the control shaft and the circular rack on the control shaft.

5. The continuously variable transmission system for an automatic as claimed in claim 4 further comprising a tension spring mounted between the antigravity blocks.

6. The continuously variable transmission system for an automatic as claimed in claim 3 further comprising another two transmission wheels, with the three transmission wheels mounted in the annular inner spherical space at regular angular intervals, each of two ends of each said support rod of one of the transmission wheels including a gear that meshes with another gear on an associated one of the support rods of an associated one of the remaining transmission wheels, allowing synchronous rotational movement of the three transmission wheels.

7. The continuously variable transmission system for an automatic as claimed in claim 3 wherein the transmission wheel comprises an elastomeric anti-sliding layer on the outer spherical face thereof.

8. The continuously variable transmission system for an automatic as claimed in claim 1 wherein the gear shifting transmission device comprises:
an input shaft including a front end to which the engine power is transmitted, the input shaft of the gear shifting transmission device further comprising a rear end on which ratchet teeth for reverse gear and ratchet teeth for forward gear are provided, the input shaft of the gear shifting transmission device further comprising an axial hole for coupling with the power input shaft of the drive wheel;
a sun gear fixed on the power input shaft of the drive wheel;
front and rear planet carriers;
a plurality of planetary gears meshed with outer circumferential teeth of the sun gear, a shaft of each said planetary gear including two ends respectively coupled to the front and rear planet carriers;
a first ratchet ring mounted on the front planet carrier for engaging with the ratchet teeth for forward gear on the input shaft;
a first brake disc mounted on a circumference of the rear planet carrier;
a plurality of first brake shoes mounted on both sides of the first brake disc;
a ring gear including inner circumferential teeth meshed with each said planetary gear;
a sleeve extending forward from a circumference of the ring gear and including an end wall that is opposite to the ring gear, with the input shaft of the gear shifting transmission device extending through the end wall;
a second ratchet ring mounted on a side of the end wall for engaging with the ratchet teeth for reverse gear on the input shaft of the gear shifting transmission device;
a second brake disc mounted on a circumference of the end wall;
a plurality of second brake shoes mounted on both sides of the second brake disc; and
a shifter coupled to the input shaft of the gear shifting transmission device for moving the input shaft along an axial direction;
wherein when the input shaft of the gear shifting transmission device is moved by the shifter to engage the ratchet teeth for forward gear on the input shaft with the first ratchet ring on the front planet carrier, the second brake shoes brake the second brake disc on the end wall of the sleeve, the drive gear and the power input shaft of the drive gear are driven in an accelerating transmission mode via the front planet carrier, the planetary gears, and the sun gear; and
wherein when the input shaft of the gear shifting transmission device is moved by the shifter to engage the ratchet teeth for reverse gear on the input shaft with the second ratchet ring on the end wall, the first brake shoes brake the first brake disc on the rear planet carrier, the drive gear and the power input shaft are driven in a reverse direction in the accelerating transmission mode via the ring gear, the planetary gears, and the sun gear.
